(19) United States
(12) Patent Application Publication
(10) Pub. No.: US 2026/0021691 A1
(43) Pub. Date: Jan. 22, 2026

(54) VEHICLE ROOF

(71) Applicant: Magna Car Top Systems GmbH, Bietigheim-Bissingen (DE)

(72) Inventor: Thorsten SCHUMACHER, Kummerfeld (DE)

(21) Appl. No.: 19/264,944

(22) Filed: Jul. 10, 2025

(30) Foreign Application Priority Data
Jul. 18, 2024 (DE) 102024120246.7

(51) Int. Cl. B60J 7/06; B60J 7/02

(52) U.S. Cl. CPC B60J 7/061; B60J 7/022

(57) ABSTRACT

The invention relates to a roof of a vehicle having a folding sliding roof which is designed to be adjustable between a closed position and an open position for the purposes of selectively closing and opening a roof opening, wherein the roof opening is delimited by a roof frame which is fastenable to a body, wherein the roof frame is assembled from individual frame parts, wherein the frame parts comprise a front transverse member, a rear transverse member and a first and a second roof side member, and wherein the first and the second roof side member are connected by way of their ends to the transverse members in connecting regions, wherein the connecting regions form front and rear corners, and wherein, in the corners, there are cut-out regions which form apertures for the leadthrough of functional elements or for providing access for the adjustment of functional systems.

### CROSS-REFERENCE TO RELATED APPLICATIONS

This application claims priority to German Application No. DE 102024120246.7 filed Jul. 18, 2024. The entire disclosure of the above application is incorporated herein by reference.

### FIELD OF THE INVENTION

The invention relates to a roof of a vehicle having a folding sliding roof which is designed to be adjustable between a closed position and an open position for the purposes of selectively closing and opening a roof opening, wherein the roof opening is delimited by a roof frame mounted on a body, and wherein the folding sliding roof comprises bows which extend transversely with respect to the vehicle longitudinal direction and which comprise a front roof surface element and a number of guide bows and folding bows, which are mounted movably in guide rails of roof side members of the roof frame.

### BACKGROUND OF THE INVENTION

This section provides information related to the present disclosure which is not necessarily prior art.

In the context of folding sliding roofs of motor vehicles, it is generally known that the top lining spanning the roof opening is supported and tensioned in the closed position by means of transverse bows that extend transversely with respect to the vehicle longitudinal axis. Here, the transverse bows are divided into folding bows and guide bows, which are arranged in alternation in the vehicle longitudinal direction and are mounted movably in guide rails of roof side members of a roof frame. As the folding sliding roof opens, only the folding bows are raised from the roof, with the result that the top lining is folded up during the opening process.

The roof frame for folding sliding roofs may, for example, be produced as a single piece from aluminium or steel in a deep-drawing process, wherein the roof frame has a trough-shaped form. In another variant, the roof frame consists of individual aluminium or steel profiles which are assembled to form the roof frame and are welded in the corner regions. The corner regions of the roof frame are then deep-drawn into a cup-like form in order to achieve a desired shape.

A roof frame produced in this way forms the carrier frame for further functional elements of the folding sliding roof and is attached to the vehicle bodyshell as the motor vehicle is fully assembled. EP 0 774 371 A2, for example, has disclosed a folding sliding roof. This roof designed as a folding sliding roof is adjustable between an open position and a closed position and also comprises a plurality of bows, which extend in a transverse direction, and a front and a rear roof element. Such a folding sliding roof comprises, on each side of the vehicle, a guide rail attached to a roof frame, and comprises a top material which is connected to bows and which is adjustable by means of said bows between an open position and a closed position. When the folding sliding roof is in the closed position, the vehicle interior is spanned and covered by the roof elements and the top material.

In the above-described known embodiments of folding sliding roofs, the size of the folding sliding roof and the different states (closed position/open position) give rise to the following technical demands or difficulties. The demands on the overall aesthetic impression in such motor vehicles having folding sliding roofs are additionally very high.

To achieve a seal in the side region of the folding sliding roof, the lateral edge regions of the top material must be tensioned when the folding sliding roof is in the closed state. For this purpose, a tension cable is provided on each side, which tension cable extends in the vehicle longitudinal direction and is guided so as to be operatively connected in the region of the lateral edge regions to the top material. The tension cable extends in particular between the front roof cap of the folding sliding roof and a rear roof surface component, which is fixed to the body or bodyshell and on which the folding sliding roof lies in the opened state. Nowadays, in an installed state of the folding sliding roof, the tension cables are adjustable with controlled force by means of tension cable systems in order, in particular in the case of relatively long roofs, to achieve an optimum with regard to tension cable stiffness and tolerance compensation, and thus to adequately counteract the ballooning effect even at relatively high vehicle speeds and to thereby keep noise to a refined level.

It is also common to provide tension straps on the folding sliding roof, which in the closed state of the folding sliding roof counteract the Bernoulli effect and subject the folding bows to a force that counteracts their spring force. The tension straps are also advantageously designed to be adjustable in terms of their tension by means of tension strap systems.

A problem with the use of such tension cable and tension strap systems is the accessibility to and adjustability of the aforementioned systems.

A further problem, in particular in the case of long vehicle roofs, is that of reducing the required drive force through optimized design of the kinematic mechanism for adjusting the front roof cap and the provided bows. During the initial adjustment in the opening process of the folding sliding roof, the roof cap is firstly raised and simultaneously displaced rearwards in positively guided fashion by means of lateral links which are held in lateral slotted guides.

The drive force required is in this case also significantly dependent on the spacing in the vehicle longitudinal direction between the attachment element between link and slotted guide and the front end region of the roof cap. A reduction of this spacing leads to a stiffer roof cap which is less sensitive to lift, which is desirable in particular in the case of relatively long folding sliding roofs.

### SUMMARY OF THE INVENTION

This section provides a general summary of the disclosure, and is not a comprehensive disclosure of its full scope or all of its features.

It is an object of the invention to further develop a roof for a vehicle, comprising a folding sliding roof which is movable between an open position and a closed position, in such a way that the aforementioned problems are avoided or solved.

This object is achieved by means of the features of a roof of a vehicle having a folding sliding roof which is designed to be adjustable between a closed position and an open position for the purposes of selectively closing and opening a roof opening, wherein the roof opening is delimited by a roof frame which is fastenable to a body, wherein the roof frame is assembled from individual frame parts, wherein the frame parts comprise a front transverse member, a rear transverse member and a first and a second roof side member, and wherein the first and the second roof side member are connected by way of their ends to the transverse members in connecting regions, wherein the connecting regions form front and rear corners, and wherein, in the corners, there are cut-out regions which form apertures for the leadthrough of functional elements or for providing access for the adjustment of functional systems.

The roof frame of the folding sliding roof is assembled from individual parts and is connected, preferably welded, in the connecting regions which form the corners.

The individual parts of the roof frame are a first and a second roof side member and a front transverse element and a rear transverse element. The individual parts are designed here as frame parts such that regions are left free in the corners, which regions form apertures in the assembled state of the roof frame.

The roof frame delimits a substantially rectangular roof opening.

The provision of apertures in the corner regions of the roof frame yields the following advantages for the folding sliding roof.

In comparison with the previous single-piece roof frame produced in a deep-drawing process and having a trough-shaped structure, the roof frame can be formed from individual parts having a greater draw depth (z direction). The guide rails attached to the side elements can thus be designed to be taller as viewed in the z direction such that they extend as far as under the seal, whereby the introduction of force into the roof surface component is optimized, and an optimized transmission ratio of the kinematic adjustment mechanism can be realized.

The optimized transmission ratio of the kinematic adjustment mechanism can be achieved by virtue of the spacing, as viewed in the x direction, from the front edge of the roof surface component to the attachment via a control element to the slotted guide being reduced in relation to the prior art. This is possible because, as viewed in the x direction, the slotted guide can be led forwards through the apertures of the front corners in the roof frame.

The slotted guide is a functional element. A reduction of this spacing gives rise to a stiffer roof surface component which is less sensitive to lift, which is important in particular in the case of relatively large roof surfaces.

By virtue of the apertures being formed in the rear corners of the roof frame, access is provided in the rear roof region to functional systems such as the tension strap systems and the tension cable systems for the purposes of adjusting the tension thereof, whereby it is made possible to adjust the tension even when the folding sliding roof is in the closed state.

The tension strap systems and tension cable systems allow the corresponding tension of the tension cable and of the tension strap to be adjusted with controlled force, and thus allow an adaptation to the particular folding sliding roof. It is expedient to be able to pull along the direct line of force action of the tension strap and tension cable, which is achieved by virtue of the apertures being formed in the rear corners.

The x, y and z directions correspond to the directions of a conventional vehicle coordinate system, in which x denotes the vehicle longitudinal direction, y denotes the transverse direction and z denotes the vertical direction.

In the installed state on the vehicle, the side parts of the roof frame extend in the x direction. The transverse elements correspondingly extend in the transverse direction.

In the context of the invention, “forwards” means in a direction towards the front end of the vehicle. In the context of the invention, “rearwards” means in a direction towards the rear end of the vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a view of a folding sliding roof from below, without a top lining, in the closed state.

FIG. 2 shows the roof frame according to the invention.

FIG. 3 shows a detail of the folding sliding roof in the front corner region, with guide rail, slotted guide, roof surface component and top lining.

FIG. 4 shows an enlarged perspective detail view of the front corner region of the roof frame, with aperture.

FIG. 5 shows a perspective detail of the folding sliding roof from below in the corner region, showing the tension cable and tension strap system in the region of the aperture of the roof frame.

### DESCRIPTION OF THE INVENTION

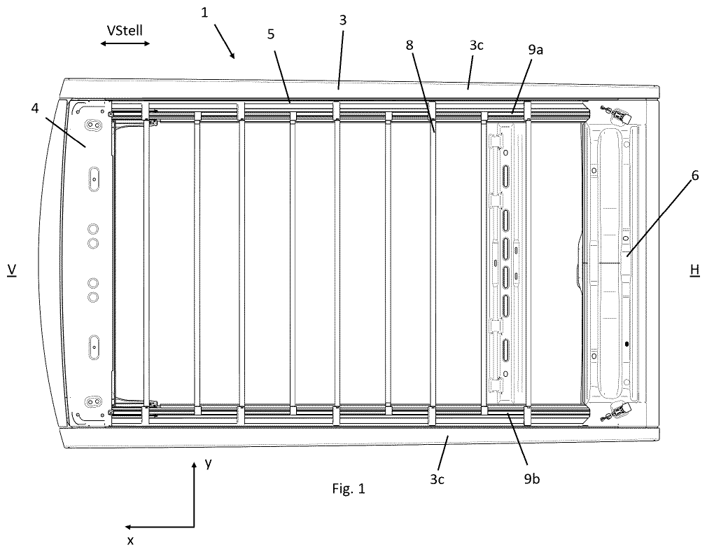

A roof 1 for a vehicle that is schematically illustrated in FIG. 1 is designed as a folding sliding roof and is designed for at least partially opening and closing a roof opening 2. The roof opening 2 of the roof 1 is delimited by an encircling roof frame 3, which comprises a front transverse member 3a, a rear transverse member 3b and oppositely situated roof side members 3c which extend in the vehicle longitudinal direction and are spaced apart in parallel.

The adjustable folding sliding roof 1 extends from the front transverse member 3a at the front end V to the rear transverse member 3b in the rear region H of the vehicle.

The roof side members 3c are formed with guide rails 5 for the purposes of movable linear movement or displacement of a roof surface component 4 in the vehicle longitudinal direction x. In the drawings, the vehicle longitudinal direction is denoted by the x coordinate, the vehicle transverse direction is denoted by the y coordinate, the front end is denoted by V, and the rear end is denoted by H. The adjustment movement of the roof surface component 4 along the guide rails 5 is indicated by the double arrow VStell. The roof surface component 4 is designed in the following exemplary embodiment as a roof surface component. In a manner known to a person skilled in the art, a top lining is attached to the roof surface component.

In the open position, the roof opening 2 is opened up, and in the closed position, the roof opening 2 is covered and completely closed by the roof surface component 4 and the top lining attached to the roof surface component 4 (FIG. 1; the top lining is not illustrated in FIG. 1). The top lining is attached in a known manner to bows 8, which each extend in the transverse direction from one guide rail 5 to the other, opposite guide rail 5 and serve for tensioning the top lining in the closed position. The guide bows are each movably mounted by way of their ends on the respective guide rails 5 by means of sliding elements. The folding bows rest on the guide rails 5 and serve to impart a folding action. The guide bows and folding bows alternate in the vehicle longitudinal direction. This basic design and the functionality are known to a person skilled in the art.

The transfer of the roof surface component 4 with top lining from the closed position into the open position and vice versa is effected by means of a drive unit which comprises a drive motor 6, a drive shaft, drive pinions, and two drive cables 9a and 9b which are rigid in compression. The drive cables 9a and 9b each extend in the longitudinal direction in the roof frame 3 in the region of the roof side members 3c; in these linear guide regions, the drive cables 9a, 9b are each connected to the roof surface component 4, such that a movement of the drive cables 9a, 9b causes the roof surface component 4 to be translationally displaced in the guide rails 5 relative to the roof frame 3 in the direction of the double arrow VStell.

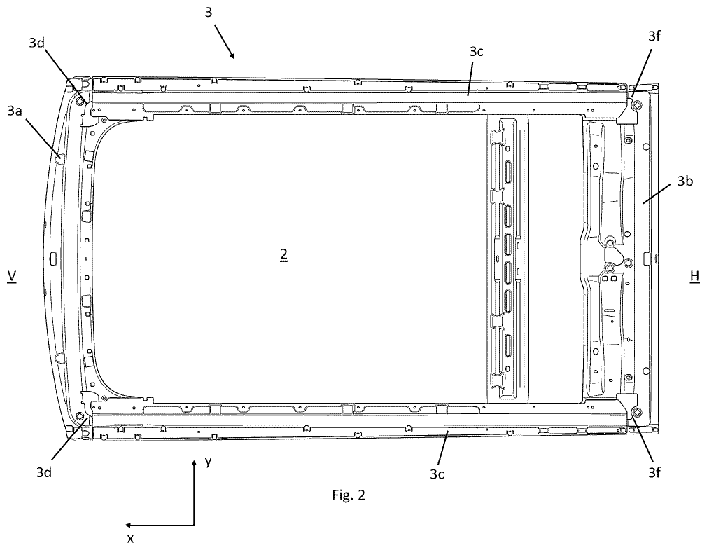

FIG. 2 shows the roof frame 3 according to the invention in a plan view. The roof frame 2 is assembled from individual parts, namely a first and a second roof side member 3c and a front transverse element 3a and a rear transverse element 3b. The individual parts are in this case produced as frame parts in a deep-drawing process. The first and the second roof side member 3c are connected by way of their ends to the transverse elements in connecting regions, forming the encircling roof frame 3 that is illustrated. The connecting regions form front and rear corners 3d, 3f. As can be seen from the drawing, in the corners 3d, 3f, there are cut-out regions which in the assembled state form apertures 10. The connecting regions are produced by means of a welded connection.

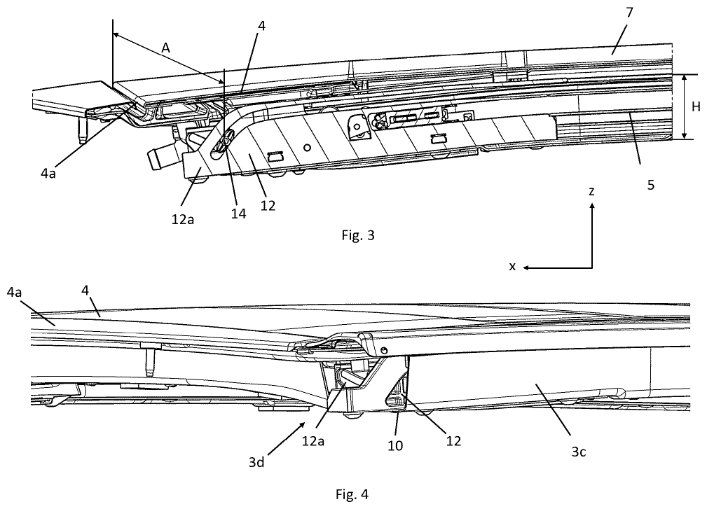

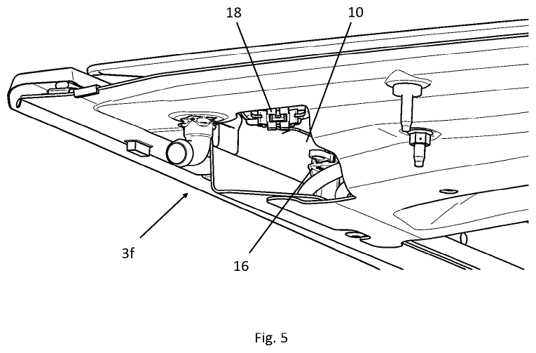

FIG. 3 shows a detail of the folding sliding roof in a front corner region, with a guide rail 5 and with a slotted guide 12 for positively controlled guidance for the purposes of raising and displacing the roof surface component 4 in the z and x directions. As can be seen from the illustration, for this purpose, a control element 14 is mounted in a guide track 15 of the slotted guide 12. The control element 14 is articulated on a side region of the roof surface component 4.

The slotted guide 12 has a front end region 12a and a height Hz in the z direction of approximately 44 mm.

From FIG. 4, which shows an enlarged perspective detail view of the front corner region of the roof frame with aperture 10 and slotted guide 12, it can be seen that the slotted guide 12 is led with its front end region 12a forwards in the x direction through the aperture 10.

This design considerably reduces the spacing A in the x direction between the control element 14 and the front edge 4a of the roof surface component 4 in relation to the prior art. The spacing A as indicated in FIG. 3 is approximately 84 mm in the exemplary embodiment shown.

In the closed state of the roof illustrated in FIG. 1, the top lining 7 is tightly tensioned. This tensioning of the top lining 7 is assisted by means of adjustable tension cable systems 18. For this purpose, in each case one tension cable 17 is guided in the lateral roof regions and is connected at the side edges to the top lining 7 and additionally applies a tension to said top lining when the roof is closed. The tension cable 17 extends in each case along the lateral guide rails 5 and is advantageously guided in an associated seal groove which is arranged on the guide rails 5. The tension cable 17 is tensioned by means of the tension cable system 18. The tension cable system is held indirectly or directly on a rear component which is fixed with respect to a bodyshell, commonly on the rear planar roof bow of the roof 1. The tension cable system 18 is an adjustable system, such that the cable tension can be adjusted for the purposes of basically setting the cable tension on the basis of manufacturing tolerances and for the purposes of readjusting the cable tension during the course of the service life of the folding sliding roof. For this purpose, the cable tensioning system 18 must be accessible even when the folding sliding roof is in the closed state.

By virtue of the apertures 10 being formed in the rear corner regions 3f of the roof frame 3, access to the tension cable systems 18 is provided in the rear roof region.

The folding sliding roof furthermore comprises adjustable tension strap systems 16, which must also be freely accessible in the rear corner regions 3f of the roof frame 3 for the purposes of adjusting the tension of the tension straps.

The tension strap systems 16 are likewise held indirectly or directly on a rear component which is fixed with respect to a bodyshell, commonly on the rear planar roof bow of the roof.

Tension strap systems 16 comprise tension straps, the tension of which is adjusted. The arrangement and design of tension strap systems are known in principle. Tension straps serve for holding the height-adjustable folding bows down when the folding sliding roof is in the closed state, and counteract the spring force that raises the folding bows for the purposes of imparting a folding action.

By virtue of the apertures 10 being formed in the rear corner regions 3f of the roof frame 3, access to the tension strap systems 16 is provided in the rear roof region.

What is claimed is:

1. A roof of a vehicle having a folding sliding roof which is designed to be adjustable between a closed position and an open position for the purposes of selectively closing and opening a roof opening, wherein the roof opening is delimited by a roof frame which is fastenable to a body, wherein the roof frame is assembled from individual frame parts, wherein the frame parts comprise a front transverse member, a rear transverse member and a first and a second roof side member, wherein the first and the second roof side member are connected by way of their ends to the transverse members in connecting regions, wherein the connecting regions form front and rear corners, and wherein, in the corners, there are cut-out regions which form apertures for the leadthrough of functional elements or for providing access for the adjustment of functional systems.

2. The roof of a vehicle according to claim 1, wherein the frame parts are produced in a deep-drawing process, and wherein the assembled roof frame has a trough-shaped structure.

3. The roof of a vehicle according to claim 1, wherein the connecting regions are produced in a welding process.

4. The roof of a vehicle according to claim 1, wherein the functional elements are slotted guides which are attached to the roof side members, and wherein the slotted guides are designed to provide positive guidance for the purposes of raising and displacing a front roof surface component of the folding sliding roof.

5. The roof of a vehicle according to claim 1, wherein the roof comprises a top lining and bows, wherein the bows comprise alternately arranged fixed-height, movably mounted guide bows and height-adjustable guide bows, which each extend in a transverse direction from a guide rail attached to the roof side member to an opposite guide rail attached to the roof side member and serve for tensioning the top lining in the closed position.

6. The roof of a vehicle according to claim 1, wherein the functional systems are arranged as tension strap systems and as tension cable systems on a rear component, which is fixed with respect to a vehicle bodyshell, of the roof and are accessible through the apertures in the rear corners for the purposes of adjusting the tension of tension cables and tension straps.
